(19) United States
(12) Patent Application Publication
(10) Pub. No.: US 2005/0198617 A1
(43) Pub. Date: Sep. 8, 2005

(54) Graphically browsing schema documents described by XML schema

(75) Inventors: Hyeokman Kim, Seoul (KR); Sanghoon Sull, Seoul (KR)

Correspondence Address: D.A. STAUFFER PATENT SERVICES LLC, 1006 MONTFORD ROAD, CLEVLAND HTS., OH, 44121-2016, US

(73) Assignee: Vivcom, Inc., Palo Alto, CA (US)

(21) Appl. No.: 11/066,609

(22) Filed: Feb. 25, 2005

Related U.S. Application Data
(60) Provisional application No. 60/550,210, filed on Mar. 4, 2004.

(51) Int. Cl. G06F 9/44

(52) U.S. Cl. 717/109; 717/114

(57) ABSTRACT

Techniques for providing graphical representations of a semantic structure of XML Schema documents which can explicitly represent not only composition/aggregation relationships between related datatypes and their child elements but also inheritance relationships between supertypes and subtypes in a single GUI screen of graphical schema browsers. Compact graphical schema diagrams for representing complex relationships between datatypes and elements inherent in XML schema documents can be generated, and can easily and quickly be browsed. The techniques disclosed herein are useful for any graphical XML Schema editor that can edit XML Schema document with the GUI screen views.

### CROSS-REFERENCE TO RELATED APPLICATIONS

This application claims priority of U.S. Provisional Patent Application No. 60/550,210 filed Mar. 4, 2004, incorporated in its entirety by reference herein.

### TECHNICAL FIELD

The disclosure relates to the processing of XML documents, and more particularly to techniques for graphically browsing schemas or document types described by XML Schema.

### BACKGROUND

XML (Extensible Markup Language) standardized by W3C (World Wide Web Consortium) is a self-describing data format, allowing authors to define a set of elements and attribute names that describe the content of a document. As XML allows the author such flexibility, it is necessary to be able to define what elements and attribute names are allowed to appear in a conforming document called a “document instance” in order to make the document useful. “Schemas” or “document types” are used for this purpose. A schema or document type defines the allowable contents or structures of a class of XML documents or document instances. The class of documents refers to all possible permutations of structure in documents that still conform to the rules of the schema. XML is more completely described in W3C Recommendation, Extensible Markup Language (XML) 1.0, 3^{rd} Edition (2004) and Beginning XML, 3^{rd} Edition (2004), David Hunter, et al., Wrox Press Ltd., both of which are incorporated in their entirety by reference herein.

“XML Schema”, also standardized by W3C is a schema language that can define document structures. In this disclosure, a schema or document type that is described by XML Schema is called as an “XML Schema document”. XML Schema introduces powerful ways to integrate core principles of object-oriented modeling concepts such as “composition”, “aggregation” and “inheritance” when defining document structures. Composition refers to a relationship in which one object contains another as its child as in a tree relationship such that the child is intrinsically bound to the parent. Without the parent, the child object has no meaning. Aggregation refers to a relationship in which one object contains another as one of its child objects, but the referenced child object can exist without the parent. Inheritance refers to another relationship in which one object inherits its definition (in terms of either structure or data field definitions) from another object and modifies it in some way. In an object-oriented schema, all composition and aggregation relationships related each other form a single tree called “composition/aggregation hierarchy”. Furthermore, if multiple inheritances are not allowed, all inheritance relationships in the schema form a single tree called “inheritance hierarchy”. In object-oriented modeling, a schema usually has complex structures because each object might participate not only in a composition/aggregation hierarchy but also in another inheritance hierarchy.

In XML Schema, the composition/aggregation relationships between related datatypes and elements are expressed by the compositors such as “sequence”, “choice”, and “all” elements. The “sequence” compositor indicates that the elements declared inside it must appear in the order in which they are declared. The “choice” compositor means that any one of the elements declared inside it can occur in the instance document, but only one of them may occur. The “all” compositor allows the elements to occur in any order, but they can only occur once or not at all. A datatype can contain a compositor or a combination of the compositors with some restrictions, where the compositors also contain several elements. Thus, a datatype can restrict the allowable content of elements, that is, child elements it can contain. In this way, the datatype has the composition/aggregation relationships with the elements. Note that a “content model” of a datatype restricts the allowable content of elements, in terms of the attributes it can carry, and child elements it can contain.

In this disclosure, the aspect of the attributes will be ignored since they are not relevant to the core concept of this disclosure. Note also that, in this disclosure, for a datatype containing more than one element via a compositor or a combination of compositors, the datatype is called as a “containing datatype” or “parent datatype” of the elements, and conversely the elements as the “contained elements” or “child elements” of the datatype.

In XML Schema, whenever users want to allow an element to contain child elements and carry attributes, they have to define a datatype having appropriate content model and then associate the element name with the datatype regardless of whether the element is contained in another datatype or not. This is called as the declaration of an element or “element declaration”.

In this disclosure, the datatype associated with an element is called as the “binding datatype” of the element or simply the datatype of the element, and the element is the “binding element” of the datatype. Furthermore, in a composition/aggregation hierarchy of an XML Schema document, an element A can indirectly contain another element B when A is associated with a binding datatype AType having B as its child element. In this case, the element A is called as a “parent element” of the element B. Also, a datatype AType can indirectly contain another datatype BType when AType has a child element B whose binding type is BType. In this case, the datatype AType is called as a “parent datatype” of the datatype BType.

Similarly, in XML Schema, the inheritance relationships between datatypes are expressed by datatype deriving mechanisms such as “extension” and “restriction” elements. A new datatype can be derived by extension from an existing base datatype, or by restriction upon another existing base datatype. The “effective content model” of a datatype that is derived by extension is the combination of the base type's content model, plus the additions specified in the new datatype. These content models are merged in sequence. Also, a new datatype derived by restriction only has values that are a subset of the base type's values. A datatype derived by either extension or restriction from an existing base type is a “subtype” of the base datatype, and the base datatype is a “supertype” of the derived datatype. XML Schema is more completely described in W3C Recommendations, XML Schema Part 0 to Part 2, 2^{nd} Edition (2004) and Professional XML Schemas (2001), Jon Duckett, et al., Wrox Press Ltd., incorporated in its entirety by reference herein.

Glossary

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used in the description contained herein:
GUI Graphical User Interface
ISO International Organization for Standardization is a network of the national standards institutes of 146 countries, on the basis of one member per country, with a Central Secretariat in Geneva, Switzerland, that coordinates the system (see World Wide Web at iso.org).
MPEG-7 Moving Picture Experts Group—Standard 7 (MPEG-7), formally named “Multimedia Content Description Interface” (MCDI) is a standard for describing the multimedia content data._More extensive information about MPEG-7 can be found at the MPEG home page (http://mpeg.tilab.com), the MPEG-7 Consortium website (see World Wide Web at mp7c.org), and the MPEG-7 Alliance website (see World Wide Web at mpeg-industry.com) as well as “Introduction to MPEG 7: Multimedia Content Description Language” (John Wiley & Sons, June, 2002) by B. S.

Manjunath, Philippe Salembier, and Thomas Sikora, and “ISO/IEC 15938-5:2003 Information technology—Multimedia content description interface—Part 5: Multimedia description schemes” (see World Wide Web at iso.org).
TV-Anytime TV-Anytime is a series of open specifications or standards to enable audio-visual and other data service developed by the TV-Anytime Forum. A more extensive explanation of TV-Anytime may be found at the home page of the TV-Anytime Forum (see World Wide Web at tv-anytime.org).
W3C World Wide Web Consortium is a consortium which develops interoperable technologies (specifications, guidelines, software, and tools) to lead the Web to its full potential. W3C is a forum for information, commerce, communication, and collective understanding. More information on W3C may be found on the World Wide Web at w3.org.
XML extensible Markup Language defined by W3C is a simple, very flexible text format derived from SGML. Originally designed to meet the challenges of large-scale electronic publishing, XML is also playing an increasingly important role in the exchange of a wide variety of data on the Web and elsewhere. An explanation on XML may be found on the World Wide Web at w3.org/XML/.
XML Schema Schema language defined by W3C expresses shared vocabularies and allow machines to carry out rules made by people. They provide a means for defining the structure, content and semantics of XML documents. An explanation on XML Schema may be found on the World Wide Web at w3.org/XML/Schema#resources.

### BRIEF DESCRIPTION (SUMMARY)

There is a need for a system and method that provides graphical representation of a semantic structure of XML Schema documents, which can explicitly represent not only composition/aggregation relationships between related datatypes and their child elements but also inheritance relationships between supertypes and subtypes in a single GUI screen of graphical schema browsers.

Generally, an efficient method and apparatus is provided for generating a compact graphical schema diagram for representing complex relationships between datatypes and elements inherent in XML schema documents, and easily and quickly browsing the graphical schema diagram.

Generally, techniques are provided for representing a semantic structure of related XML Schema documents in a compact graphical schema diagram, which can explicitly represent not only composition/aggregation relationships between datatypes and elements but also inheritance relationships between datatypes. In the schema diagram, each schema component including an element, a datatype, or an element associated with a datatype is represented with a rectangular box (or other suitable equivalent visually distinct and intuitively representative of intended functionality symbol or graphical element). In the schema diagram, horizontal arrows (or other suitable equivalent visually distinct and intuitively representative of intended functionality symbol or graphical element) between rectangular boxes represent composition/aggregation relationships between datatypes and elements, and vertical arrows (or other suitable equivalent visually distinct and intuitively representative of intended functionality symbol or graphical element) between rectangular boxes represent inheritance relationships between datatypes. Each compositor may be represented with a small distinguished graphical symbol located on the arrows standing for a composition/aggregation relationship. The compositor is a semantic tool of XML Schema that is used to create a group of element declarations. It provides a rule for all elements declared within it the elements must occur in the same order as which they are declared.

The schema diagram can be utilized for any graphical diagram representing composition/aggregation relationships and inheritance relationships between objects or datatypes concurrently in a single diagram.

Generally, techniques are provided for browsing the schema diagram of related XML Schema documents with a graphical schema browser that can control the navigations through the schema diagram with a GUI screen of the browser. In an embodiment, the GUI screen comprises five major parts (elements):
a list view of schema components,
a list view of binding elements,
a list view of parent datatypes,
a list view of supertypes, and
a graphical view of schema diagram.

With the GUI screen of the graphical schema browser, the list view of schema components provides a list of all datatypes and elements defined in related XML Schema documents including global and local elements, and complex and simple datatypes. By selecting a datatype or element from the list, the rectangular box standing for the selected datatype or element appears at the graphical view of schema diagram, and users can start to navigate from the selected one.

With the GUI screen of the graphical schema browser, the list view of binding elements provides a list of feasible binding elements of a datatype if they exist. By selecting an element from the list, the datatype is associated with the element.

With the GUI screen of the graphical schema browser, the list view of parent datatypes provides a list of feasible parent datatypes of an element if they exist. By selecting a parent datatype from the list, the rectangular box standing for the selected parent datatype appears at the graphical view of schema diagram, and users can navigate backward from the element to the selected parent datatype.

With the GUI screen of the graphical schema browser, the list view of supertypes provides a list of feasible supertypes of a datatype if they exist. By selecting a supertype from the list, the rectangular box standing for the selected supertype appears at the graphical view of schema diagram, and users can navigate upward from the datatype to the selected supertype.

With the graphical view of schema diagram at the GUI screen of the graphical schema browser, a rectangular box standing for a datatype can have a subtype indicator when the subtypes of the datatype exist. By clicking on (selecting) the subtype indicator, the subtypes become unfolded and users can navigate downward through the unfolded subtypes. By clicking on the indicator again, the subtypes become folded.

With the graphical view of schema diagram at the GUI screen of the graphical schema browser, a rectangular box standing for a datatype can have a supertype indicator when the supertypes of the datatype exist. By clicking on the supertype indicator, the supertype becomes unfolded and users can navigate upward through the unfolded supertypes. By clicking on the indicator again, the subtypes become folded.

With the graphical view of schema diagram at the GUI screen of the graphical schema browser, a rectangular box standing for an element can have a parent indicator when the parent datatypes of the element exist. By clicking on the parent indicator, the parent datatype becomes unfolded and users can navigate backward through the unfolded parent datatypes. By clicking on the indicator again, the parent datatype becomes folded.

With the graphical view of schema diagram at the GUI screen of the graphical schema browser, child elements of a subtype can be graphically represented either in one of inherited or un-inherited mode, when they are unfolded. In an inherited mode of a subtype, all child elements that are not only locally declared in the subtype but also inherited from its supertypes are unfolded. But, in an un-inherited mode of a subtype, only child elements that are locally declared in the subtype are unfolded. The two modes can be switched each other using an inheritance indicator appearing around the subtype when the child elements of the subtype are unfolded.

According to an embodiment of the techniques of the present disclosure, a Graphical User Interface (GUI) representing composition/aggregation relationships in an XML Schema document comprises providing tree views that represent a composition/aggregation hierarchy between related datatypes and elements; graphically representing inheritance relationships indirectly through the composition/aggregation hierarchy; and graphically representing an inheritance hierarchy while displaying the composition/aggregation hierarchy. The GUI graphically supports not only forward but also backward navigation capabilities. A graphical indication may be provided for existence of binding elements of a given datatype and another graphical indication for existence of parent datatypes of a given element; and graphical tools are provided with which users can choose one of the binding elements of a given datatype and one of the parent datatypes of a given element. A graphical indication may be provided for existence of subtypes and links to them; and graphical tools may be provided with which users can navigation downward from a datatype to one of its subtypes. A graphical indication may be provided for existence of supertypes and links to them; and graphical tools may be provided with which users can navigation upward from a datatype to one of its supertypes.

According to an embodiment of the techniques of the present disclosure, a method of providing a graphical representation of a semantic structure of an XML Schema document, comprises: explicitly representing composition/aggregation relationships between related datatypes and their child elements and inheritance relationships between supertypes and subtypes in a single GUI screen of a graphical schema browser; generating a compact graphical schema diagram for representing complex relationships between datatypes and elements inherent the XML schema document by providing means for easily and quickly browsing the graphical schema diagram.

The techniques disclosed herein, such as for browsing a schema diagram, are useful for any graphical XML Schema editor that can edit XML Schema document with the GUI screen views.

Other objects, features and advantages of the techniques disclosed herein will become apparent from the ensuing descriptions thereof.

### BRIEF DESCRIPTION OF THE DRAWINGS

Reference will be made in detail to embodiments of the techniques disclosed herein, examples of which are illustrated in the accompanying drawings (figures). The drawings are intended to be illustrative, not limiting, and it should be understood that it is not intended to limit the techniques to the ideated embodiments.

FIG. 1 is a diagram illustrating an exemplary graphical schema diagram where all schema components including datatypes and elements and their relationships are represented graphically, according to an embodiment of the techniques of the present disclosure.

FIG. 2 is a representation illustrating a conceptual GUI screen of conventional graphical schema browsers, particularly GUI screen similar to Altova's XML Spy, according to the prior art.

FIGS. 3A, 3B, 3C are diagrams illustrating three consecutive exemplary schema diagrams that are displayed in sequence at the graphical view of schema diagram 206 of the conventional GUI screen 202 in FIG. 2, when navigating through the schema in Table 1 from element A, according to the prior art.

FIGS. 4A, 4B, 4C, 4D are diagrams illustrating four consecutive exemplary schema diagrams that are displayed in sequence at the graphical view of schema diagram 206 of the conventional GUI screen 202 in FIG. 2, when navigating through the schema in Table 1 from an element having a supertype, for example, element F, according to the prior art.

FIG. 5 is a representation illustrating an exemplary GUI screen of a graphical schema browser, according to an embodiment of the techniques of the present disclosure.

FIGS. 6A, 6B, 6C, 6D, 6E, 6F are diagrams illustrating six consecutive exemplary schema that are displayed in sequence at the graphical view of schema diagram 512 of the exemplary GUI screen 502 in FIG. 5, when navigating forward and downward from element A in Table 1, according to an embodiment of the techniques of the present disclosure.

FIGS. 7A, 7B, 7C, 7D are diagrams illustrating four consecutive exemplary schema that are displayed in sequence at the graphical view of schema diagram 512 of the exemplary GUI screen 502 in FIG. 5, when navigating upward from a particular element having a supertype, for example, element F in Table 1, according to an embodiment of the techniques of the present disclosure.

FIGS. 8A, 8B, 8C, 8D, 8E are diagrams illustrating five consecutive exemplary schema that are displayed in sequence at the graphical view of schema diagram 512 of the exemplary GUI screen 502 in FIG. 5, when navigating backward from a particular element having parent datatypes, for example, element E in Table 1, according to an embodiment of the techniques of the present disclosure.

FIG. 9 is a diagram illustrating an exemplary schema component standing for an element, a datatype or an element associated with a datatype, shown at the graphical view of schema diagram 512 of the exemplary GUI screen 502 in FIG. 5, according to an embodiment of the techniques of the present disclosure.

### DETAILED DESCRIPTION

When defining new schemas or reviewing/modifying existing schemas, it would be desirable to get a global view on the schemas. However, it is very tedious and time-consuming and even difficult to browse XML Schema documents only with their original textual representations. So, some software tools that allow users to quickly and easily browse the contents of XML Schema documents have already been developed. Such tools represent the contents of XML Schema documents as an easily navigable hierarchical tree that is represented textually or graphically, or both.

One of the key components for browsing XML Schema documents is to represent the composition/aggregation relationships between datatypes and their child elements and the inheritance relationships between supertypes and their subtypes defined in the documents. Several methods have been proposed for textual and graphical schema browsing.

The currently available schema browsers called Schema Viewer 1.0 by Frank Kilkelly, xmlArchitect by SysOnyx corporation and XSBrowser by LuMriX corporation have textual schema browsing functionality that represents a composition/aggregation hierarchy described in an XML Schema document as a tree view. The tree view is similar to the tree view of Microsoft's Windows Explorer where a composition/aggregation relationship between a folder and its sub-folder is represented with folder names, folder icons and a dashed line connecting the folder icon to its sub-folder icon. In the tree views of above-mentioned tools, a composition/aggregation relationship between a datatype and one of its child elements is also represented with the datatype name and its corresponding icon that stands for semantics of the datatype, the element name and its corresponding icon that also stands for semantics of the element, and a line connecting the datatype and its child element icons. Using such tree view tools, it is easy and convenient to navigate composition/aggregation relationships between datatypes and elements. However, without viewing the original document while finding a base datatype of “extension” or “restriction” element, it is inconvenient and even very hard to navigate inheritance relationships between supertypes and subtypes in succession.

Another product called XML Spy by Altova GmbH has graphical browsing functionality that represents a composition/aggregation hierarchy described in an XML Schema document as a graphical diagram. In the diagram, an element or a datatype is represented as a rectangular box having their name inside the box respectively. A box can have both element and datatype names inside it when they are bound each other, that is, the datatype is a binding datatype of the element. A composition/aggregation relationship between a datatype and one of its child elements is graphically represented such that the two boxes standing for the datatype and the child element respectively are connected with a line. If the child element has its own binding datatype, the box standing for the element can have both element name and its binding datatype name inside the box. Furthermore, for a datatype and all its child elements in a composition/aggregation hierarchy, the effective content model of the datatype is represented by graphically distinguishing between the child elements locally defined in it and those inherited from its supertypes. That is, when representing the effective content model of a datatype graphically, all child elements inherited from its supertypes are surrounded with a separate yellow dashed box if they exist. So, while navigating the composition/aggregation hierarchy and staying at a specific datatype, users can easily identify its child elements locally defined in it and those inherited from its supertypes if they exist.

The graphical user interfaces (GUIs) of the conventional methods can represent composition/aggregation relationships in an XML Schema document by providing tree views that represent a composition/aggregation hierarchy between related datatypes and elements. Furthermore, the GUI of Altova's XML Spy can graphically represent inheritance relationships indirectly through the composition/aggregation hierarchy using a separate yellow dashed box that surrounds all inherited child elements. However, the conventional GUIs do not graphically represent an inheritance hierarchy while displaying the composition/aggregation hierarchy, thus they might have, at least, the following problems.

First, for a datatype in a composition/aggregation hierarchy of an XML Schema document, it is possible to navigate to one of its child elements using the conventional GUIs. For an element in the hierarchy, it is also possible to navigate to one of its child elements via the binding datatype of the given element. From the viewpoint of the composition/aggregation hierarchy, the direction of the navigation from a datatype or an element to one of its child elements is “forward”, that is, a direction from a root to leaves of the composition/aggregation hierarchy. However, it might be inconvenient to navigate to the parent datatypes of a given element or datatype using the conventional GUIs. That is, the conventional GUIs may not support easy “backward” navigation from an element or a datatype to its parent datatype, that is, navigation along a direction from leaves to a root of the hierarchy. In an XML Schema document, a datatype can be associated with several elements as a datatype like an integer can be associated with several variables in computer programs written by programming languages. Similarly, an element can be contained in several datatypes. Thus, according to this disclosure, it is proposed that it would be more convenient if a GUI could graphically support not only forward but also backward navigation capabilities. The graphical backward navigation capability will provide graphical tools with which users can choose one of the binding elements of a given datatype and one of the parent datatypes of a given element by just clicking on their graphical symbols.

Second, for a datatype in a composition/aggregation hierarchy of an XML Schema document, it is inconvenient to navigate to one of its subtypes using the conventional GUIs because there may be no graphical indication for existence of the subtypes and links to them. Thus, in order to navigate to one of the subtypes of the given datatype, users may have to find datatypes having an extension or restriction element that specifies the datatype as its base datatype by viewing the textual schema document. Furthermore, in order to navigate through all of its descendent datatypes, users may have to repetitively find sub-subtypes of each subtype usually by viewing the textual document. However this non-graphical process might be inconvenient because users have to frequently change modes between graphical and textual browsing modes though the conventional GUIs provide graphical browsing capabilities. From the viewpoint of an inheritance hierarchy of the XML Schema document, the direction of the navigation from a datatype to one of its subtypes is “downward”, that is, a direction from a root to leaves of the inheritance hierarchy.

Third, for a datatype in a composition/aggregation hierarchy of an XML Schema document, it is similarly inconvenient to navigate to one of its supertypes using the conventional GUIs because there may be no graphical indication for the existence of supertypes and links to them. Thus, in order to navigate to one of the supertypes, users might have to find a base datatype of an extension or restriction element of the datatype by viewing the textual schema document. Note that the base datatype is its supertype. Furthermore, in order to navigate through all its ancestor datatypes, users might have to repetitively find super-supertypes of each supertype by viewing the textual document. However, the non-graphical process is also very inconvenient for users. From the viewpoint of an inheritance hierarchy of the given XML Schema document, the direction of the navigation from a datatype to one of its supertypes is “upward”, that is, a direction from leaves to a root of the inheritance hierarchy.

Especially for the GUI of Altova's XML Spy, users might become aware of the existence of supertypes of a given datatype according to the yellow dashed box surrounding all inherited child elements of the supertype, where the supertype name appears on top of the dashed box. With the GUI, the users know the supertype name of the given datatype without searching for an extension or restriction element of the given datatype by viewing the textual schema document. The users can thus navigate to the supertype by just clicking the supertype name on the list of datatype names. However, when the users decide to navigate to the supertype, the GUI screen will erase all current composition/aggregation hierarchy and refresh to display the contents of the supertype, that is, another composition/aggregation hierarchy rooted at the supertype. In this case, if the users want to go back to the given datatype immediately after the screen change or sometimes after navigating through the new hierarchy, there might be no way to go back without viewing the textual document. Thus, it would be more convenient if the two hierarchies of the XML Schema document, that is, a composition/aggregation hierarchy and an inheritance hierarchy, could be concurrently displayed or coexist in a single GUI screen. By viewing the two hierarchies in a single GUI screen, it will be possible to go back to the previous datatype without changing the displayed composition/aggregation hierarchy. This is just a simple example of a downward navigation after an upward navigation. Any combination of forward, backward, downward and upward navigations will occur while browsing an XML Schema document.

For an XML Schema document, the conventional GUIs mainly support the forward navigation capability along a composition/aggregation hierarchy of the document. However, backward navigation along the composition/aggregation hierarchy, downward and upward navigations of an inheritance hierarchy of the document would be also very useful in order to quickly and easily understand and get a global view of a semantic structure of the document. When utilizing the forward, backward, downward and upward navigations, it would be more convenient that a composition/aggregation hierarchy and an inheritance hierarchy described in an XML Schema document could be concurrently displayed or coexist in a single GUI screen. For example, MPEG-7 is art international standard XML Schema document that is developed by ISO for the purpose of describing multimedia contents. In the MPEG-7 standard specification document consisting of more than one thousand pages, there are more than 650 elements and 370 types, all of them are related through various composition/aggregation and inheritance relationships. Thus, the relationships form a big composition/aggregation hierarchy having a root element called “Mpeg7” and another big inheritance hierarchy under the root datatype called “anyType”. With large schemas such as the PEG-7 standard, it is very difficult to review and get a global view of a semantic structure of the schema without efficient graphical browsing capabilities. Especially, in XML Schema, an X Schema document can include or import other XML Schema documents. In this case, the resulting schema document often becomes large or huge in size. The efficient browsing capabilities are thus really needed.

Exemplary Implementations

In the description that follows, various features are described largely in the context of a familiar user interface, such as the Microsoft Windows™ operating system and graphic user interface (GUI) environment. It should be understood that although certain operations, such as clicking on a button, selecting a group of items, drag-and-drop, and the like, are described in the context of using a graphical input device, such as a mouse, it is within the scope of this disclosure that other suitable input devices, such as keyboard, voice or other audio input, optical or other optical video input, tablets, and the like, could alternatively be used to perform the described functions. Also, where certain items are described as being highlighted or marked, so as to be visually distinctive from other (typically similar) items in the graphical interface, that any suitable means of highlighting or identifying or marking the items visually, audibly or otherwise can be employed, and that any and all such alternatives are within the intended scope of the disclosure.

Table 1 illustrates an exemplary schema document described by XML Schema. The XML Schema document consists of ten named datatypes each of which corresponds to its named element.

For Example:

The binding datatype of element A is AType that has child elements B and C in its content model. Since elements B and C are declared inside a “sequence” compositor of element A's content model (i.e. AType), elements B and C in a conforming instance document are required to appear as children of element A in the same order in which they are declared.
The binding datatype of element B, BType, has also child elements D and E whose binding datatypes are DType and EType respectively. Similarly, elements D and E are declared inside a “choice” compositor of element B's content model (i.e. BType). Thus, only one of elements D and E would be allowed to appear as a child of element B in an instance document, but not both.
The binding datatype of element C is CType. Each of the datatypes FType and IType of elements F and I is derived by extension from datatype BType using the extension element. That is, the datatypes FType and IType are subtypes of BType, and inversely the datatype BType is a supertype of FType and IType. Thus, the effective content model of the subtypes FType and IType are the combination of BType's content model, plus the additions specified in the derived subtypes respectively. These content models are merged in sequence.
The binding datatype of element F, FType, has its own child elements G and H whose binding datatypes are GType and HType, respectively. Also, the binding datatype of element I, IType, has a child element J whose binding datatype is JType. In the table, only BType, FType and IType in their definitions have an attribute b, f, and i respectively.

In the table, all datatypes are declared as global datatypes such that they are direct children of the schema element. Also, the elements A, F and I are declared as global elements, and the others as local elements. The globally declared datatypes and elements, except a root element A, could also be locally declared.

TABLE 1
Example of an XML Schema document

```
<?xml version=“1.0” encoding=“UTF-8”?>
<schema targetNamespace=“this:document”
        xmlns:test=“this:document”
        xmlns=“http://www.w3.org/2001/XMLSchema”
        elementFormDefault=“qualified”
        attributeFormDefault=“unqualified”>
  <element name=“A” type=“test:AType”/>
  <complexType name=“AType”>
    <sequence>
      <element name=“B” type=“test:BType”/>
      <element name=“C” type=“test:CType”/>
    </sequence>
  </complexType>
  <complexType name=“BType”>
    <choice>
      <element name=“D” type=“test:DType”/>
      <element name=“E” type=“test:EType”/>
    </choice>
    <attribute name=“b” type=“integer”/>
  </complexType>
  <complexType name=“CType”/>
  <complexType name=“DType”/>
  <complexType name=“EType”/>
  <element name=“F” type=“test:FType”/>
  <complexType name=“FType”>
    <complexContent>
      <extension base=“test:BType”>
        <all>
          <element name=“G” type=“test:GType”/>
          <element name=“H” type=“test:HType”/>
        </all>
        <attribute name=“f” type=“string”/>
      </extension>
    </complexContent>
  </complexType>
  <complexType name=“GType”/>
  <complexType name=“HType”/>
  <element name=“I” type=“test:IType”/>
  <complexType name=“IType”>
    <complexContent>
      <extension base=“test:BType”>
        <sequence>
          <element name=“J” type=“test:JType”/>
        </sequence>
        <attribute name=“i” type=“string”/>
      </extension>
    </complexContent>
  </complexType>
  <complexType name=“JType”/>
</schema>
```

A schema described in related XML Schema documents can be graphically represented by drawing schema components with appropriate graphical symbols. In an exemplary graphical schema diagram, a perimeter line such as a rectangular box can represent an element, a datatype, or an element associated with its binding datatype. When the rectangular box represents an element or a datatype, the element name or datatype name appears inside the box respectively. The datatype name with a leading colon character appears just above a box representing the datatype. When the rectangular box represents an element associated with its binding datatype, both the element name and its binding datatype name appear inside the box.

In these three cases, some graphical representation for distinguishing between element and datatype names may be provided. For example, using bold characters for an element name and regular (not bold) characters for a datatype name; for example using no leading character for an element name and a leading character such as a colon for a datatype name, or slight variations of the rectangular boxes for each case by varying their shapes or line thickness. In this disclosure, the datatype name is distinguished with the element name by having a leading colon character.

A composition/aggregation relationship between a datatype and one of its child elements may be represented with an arrow from the datatype to the child element. Also, the compositor used in composition/aggregation relationships is represented with a small graphical symbol that is located on the arrows representing the relationships. The graphical symbols may include a small circle, a small triangle, and a small square representing the “sequence”, “choice”, and “all” compositors, respectively. An inheritance relationship between a datatype and a subtype may be represented with a bold arrow from the datatype to its subtype.

In the example of a schema diagram described herein, all arrows that represent composition/aggregation relationships are drawn horizontally from left to right, and all bold arrows that represent inheritance relationships are drawn vertically from top to bottom. That is, in the schema diagram where all composition/aggregation and inheritance relationships are explicitly drawn, they can be always differentiated according to the directions of the arrow (horizontal or vertical) or thickness of the arrows (regular or bold). Therefore, horizontal trace of datatypes via arrows from left to right or inverse direction means navigating related datatypes and elements through a composition/aggregation hierarchy. Similarly, vertical trace of datatypes via bold arrows from top to bottom or inverse direction means navigating related datatypes through an inheritance hierarchy.

While browsing the schema diagram and staying at a specific datatype or element, users can easily identify its location in both the composition/aggregation and inheritance hierarchies and continue to navigate through other related elements or datatypes along the hierarchies in any direction they want. The direction includes forward and backward along the composition/aggregation hierarchy, and upward and downward along the inheritance hierarchy. This will greatly help users not only to easily and quickly get a global view on the whole or partial semantic structure of a schema but also to decide which datatype or element they will browse next.

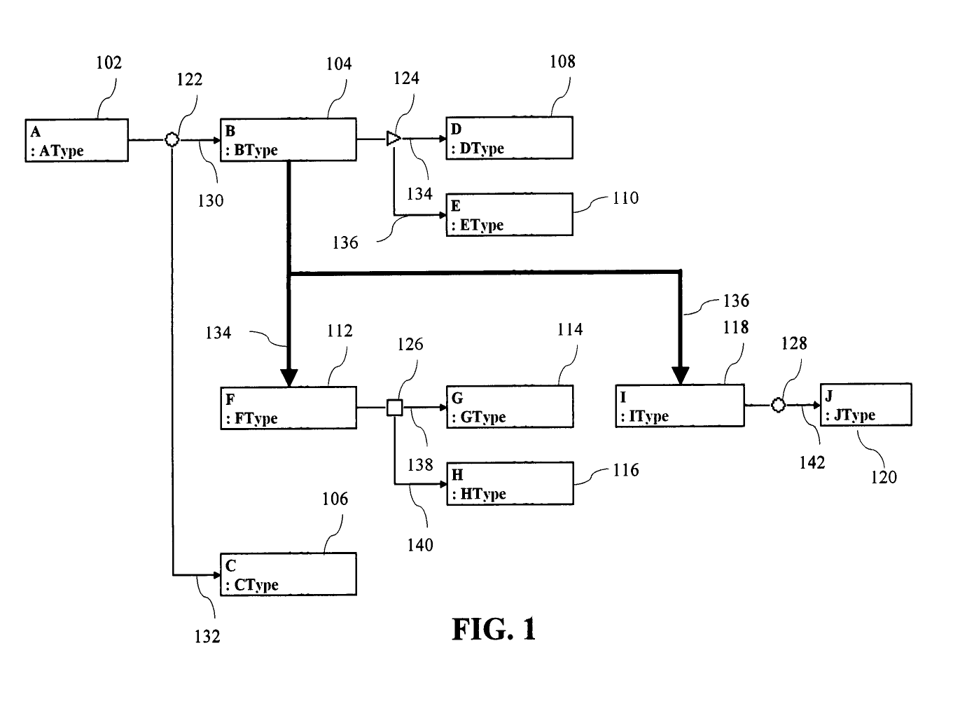

FIG. 1 is an exemplary graphical schema diagram of the exemplary schema document in Table 1 where schema components including datatypes and elements and their relationships are represented graphically. In the figure, all ten elements associated with binding datatypes are represented by separate rectangular boxes labeled with reference numerals 102, 104, 106, 108, 110, 112, 114, 116, 118, 120, and with the datatype and element names presented within the boxes. Note that each datatype name has a leading colon character to distinguish it with its binding element names. Two composition/aggregation relationships between datatype AType 102 and its child elements B 104 and C 106 are represented with two horizontal arrows connecting AType to B 130 and AType to C 132, respectively. On the arrows, there is a small circle 122 that corresponds to the sequence compositor declared in AType. The other composition/aggregation relationships are also represented with horizontal arrows 134, 136, 138, 140, 142 on which there are a small triangle 124, a small square 126 and another small circle 128 according to their compositors respectively. Similarly, two inheritance relationships between supertype BType 104 and its two subtypes FType 112 and IType 118 are represented with two bold vertical arrows connecting BType to FType 134, and BType to IType 136, respectively. Note that all regular arrows are drawn horizontally from left to right, and all bold arrows are drawn vertically from top to bottom.

A schema diagram such as the schema diagram illustrated in FIG. 1 is likely to be so large that the whole diagram cannot be displayed in a limited size of a single computer screen. Thus, the schema browsers disclosed herein provide functionalities for the user to control which portion of the schema diagram will be displayed on a screen by hiding unnecessary portions and exposing a new portion of interest.

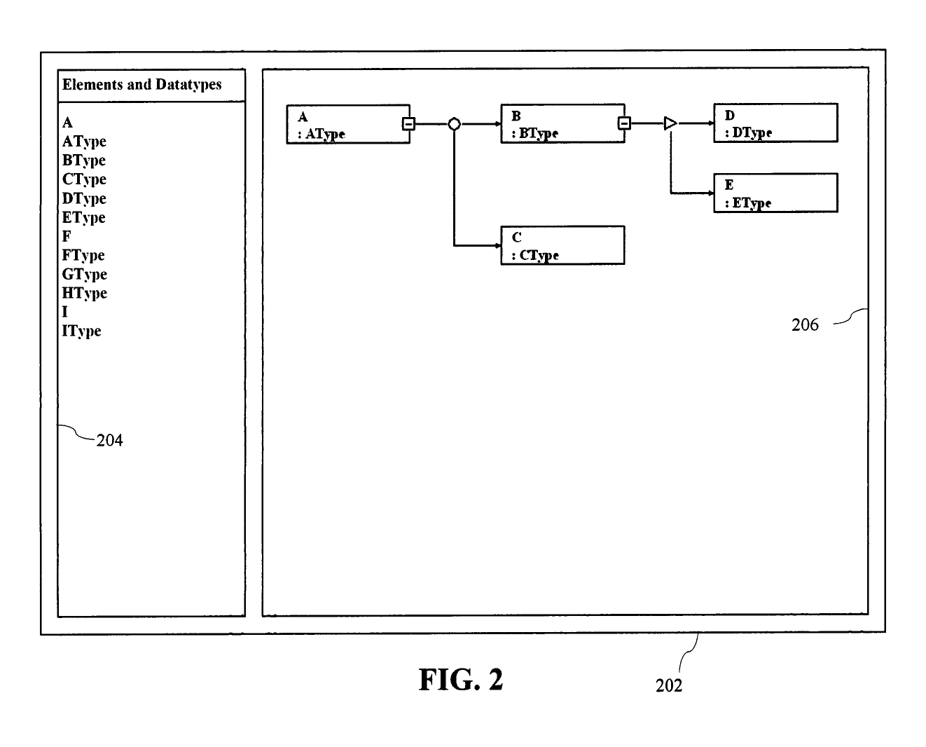

FIG. 2 illustrates a conceptual GUI screen of conventional graphical schema browsers, particularly GUI screen similar to Altova's XML Spy. The GUI screen 202 consists of two major parts: a list view of schema components 204 and a graphical view of schema diagram 206. The list view of schema components 204 provides a flat list of datatypes and elements defined in an XML Schema document. If a user selects a schema component in the list view 204, a composition/aggregation hierarchy rooted at the component will be displayed at the graphical view 206. In the hierarchy of the graphical view 206, the selected schema component and its child elements are connected with horizontal arrows.

The user can navigate to one of the child elements by selecting the rectangular box corresponding to a child element of interest. If the user selects a child element with a mouse click on it, the child elements of the selected element (grandchild elements of the schema component) will also be displayed at the graphical view 206 while being connected to the child elements with horizontal arrows. By doing so, the user can selectively navigate through schema components forward along the composition/aggregation hierarchy. However, in the GUI screen 202, it might be inconvenient to navigate through schema components backward along the composition/aggregation hierarchy because there are no graphical tools to be able to notify a user which datatype or element is a parent of the current root of the composition/aggregation hierarchy displayed at the graphical view 206. Furthermore, it might be also inconvenient to navigate through schema components upward and downward along an inheritance hierarchy because the schema diagram displayed at the conventional graphical view 206 cannot describe the inheritance hierarchy explicitly, such as in FIG. 1 where the composition/aggregation hierarchy and the inheritance hierarchy can be described simultaneously in a single diagram. That is, the schema diagram displayed at the graphical view 206 only describes a composition/aggregation hierarchy.

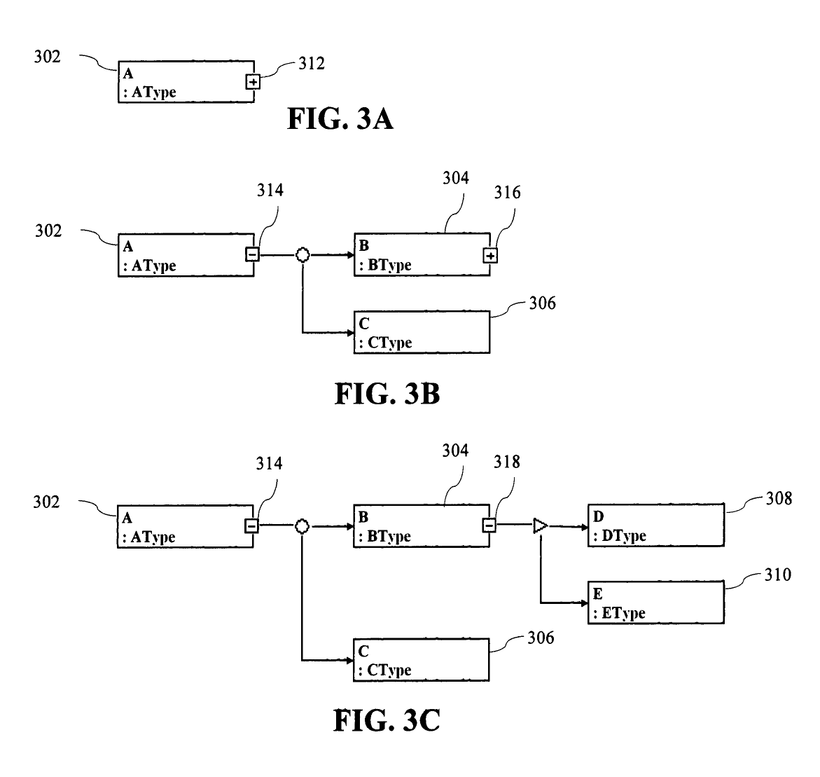

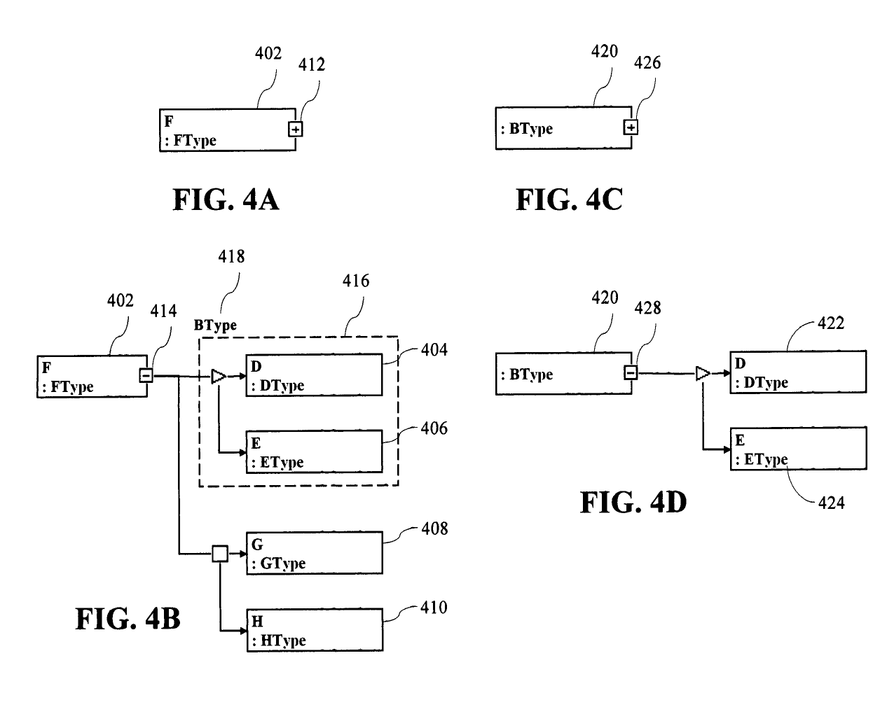

FIGS. 3A, 3B, 3C, 4A, 4B, 4C and 4D further describe the limitations of the GUI screen of the conventional graphical schema browser in FIG. 2. FIGS. 3A, 3B, 3C illustrate three consecutive exemplary schema diagrams that are displayed in sequence at the graphical view of schema diagram 206 of the conventional GUI screen 202 in FIG. 2, when navigating through the schema in Table 1 from element A.

FIG. 3A shows an exemplary schema diagram displayed at the graphical view 206 when a user selects element A from the list view 204. In the figure, element A and datatype AType are inside the rectangular box 302 since they are bound. Also, the small square having a “+” (plus) sign inside it 312 appears on a center of right vertical line of the rectangular box standing for A 302. It is a “child indicator” that appears on a center of right vertical line of a rectangular box standing for an element or a datatype when the element or datatype has child elements. For the rectangular box, the existence of a child indicator having a “+” sign specifies that the element or datatype corresponding to the box has child elements, but they are folded. FIG. 3B shows the next schema diagram displayed at the graphical view 206 when the user clicks on the child indicator 312 of element A 302 in FIG. 3A. In FIG. 3B, the sign inside the child indicator 314 of element A 302 has changed from “+” into “−” (minus), which specifies that element A has child elements B 304 and C 306, and now they are unfolded by connecting AType302 to B 304, and AType 302 to C 306 with two horizontal arrows, respectively. Note that the box standing for B 304 has also another child indicator having a “+” sign inside it. Similarly, FIG. 3C shows the next schema diagram displayed at the graphical view 206 when the user clicks on the child indicator 316 of element B 304 in FIG. 3B. In FIG. 3C, the sign inside the child indicator 318 of element B 304 has also changed from “+” into “−”, which specifies that B has child elements D 308 and E 310, and now they are unfolded by connecting BType304 to D 308, and BType 304 to E 310 with two horizontal arrows, respectively. In doing so, the user can navigate forward with just mouse clicking. The child indicator acts as a toggle switch. That is, the child elements of a datatype are folded and unfolded by clicking on the child indicator of the datatype.

The conventional graphical schema browser graphically represents the existence of child elements of a given datatype or element using the child indicator. However, the browser does not provide easy graphical tools that can specify not only the existence of parents of a given element or datatype but also their names. For example, if a user initially selects element B in the list view 204 in FIG. 2, the user can navigate forward to child elements D and E of B by clicking on a child indicator of element B. But, the user might not be able to navigate backward to parent element A of B since there is no graphical indication on the existence of A. That is, backward navigation is not easy with the conventional graphical schema browser.

The conventional graphical schema browser cannot graphically represent the existence of subtypes. So, it might be inconvenient to navigate through its subtypes without viewing original textual schema document. For example, in FIGS. 3A, 3B and 3C, users might not navigate to FType and IType that are the subtypes of BType since users are not able to know the existence of the subtypes. It might cause serious problems when BType is declared as an “abstract datatype” or element B as an “abstract element”. Abstract datatype or abstract element in XML Schema is a mechanism to force substitution for a specific datatype or element by preventing its appearance in any instance documents. This is accomplished by declaring the datatype or element to be abstract using an abstract attribute of a complexType element or an element element.

For example, Table 2 is a slight modification of Table 1 by adding an abstract attribute to the declaration of BType and deleting element declarations for elements F and I. In Table 2, BType is now an abstract datatype. Thus, in the instance documents conforming to the schema in Table 2, element B whose binding datatype is abstract should be associated with either FType or IType that is non-abstract datatype and is derived from BType. The element B can not be directly associated with its binding datatype BType since BType is an abstract datatype. In this case, easy navigation from an element to the subtypes of its binding abstract datatype (in Table 2, from B to FType or IType) might be quite essential. However, for the conventional graphical schema browser, the semantic of abstract datatypes or elements is not graphically represented. Thus, users are not able to know that the elements G, H or J might be child elements of the element B.

TABLE 2
Example of an XML Schema document (abstract datatype)

```
<?xml version=“1.0” encoding=“UTF-8”?>
<schema targetNamespace=“this:document”
        xmlns:test=“this:document”
        xmlns=http://www.w3.org/2001/XMLSchema
        elementFormDefault=“qualified”
        attributeFormDefault=“unqualified”>
  <element name=“A” type=“test:AType”/>
  <complexType name=“AType”>
    <sequence>
      <element name=“B” type=“test:BType”/>
      <element name=“C” type=“test:CType”/>
    </sequence>
  </complexType>
  <complexType name=“BType” abstract=“true”>
    <choice>
      <element name=“D” type=“test:DType”/>
      <element name=“E” type=“test:EType”/>
    </choice>
    <attribute name=“b” type=“integer”/>
  </complexType>
  <complexType name=“CType”/>
  <complexType name=“DType”/>
  <complexType name=“EType”/>
  <complexType name=“FType”>
    <complexContent>
      <extension base=“test:BType”>
        <all>
          <element name=“G” type=“test:GType”/>
          <element name=“H” type=“test:HType”/>
        </all>
        <attribute name=“f” type=“string”/>
      </extension>
    </complexContent>
  </complexType>
  <complexType name=“GType”/>
  <complexType name=“HType”/>
  <complexType name=“IType”>
    <complexContent>
      <extension base=“test:BType”>
        <sequence>
          <element name=“J” type=“test:JType”/>
        </sequence>
        <attribute name=“i” type=“string”/>
      </extension>
    </complexContent>
  </complexType>
  <complexType name=“JType”/>
</schema>
```

FIGS. 4A, 4B, 4C and 4D illustrate four consecutive exemplary schema diagrams that are displayed in sequence at the graphical view of schema diagram 206 of the conventional GUI screen 202 in FIG. 2, when navigating through the schema in Table 1 from an element having a supertype, for example, element F.

FIG. 4A shows an exemplary schema diagram displayed at the graphical view 206 when a user selects element F whose binding datatype is FType from the list view 204. In the figure, element A and datatype AType are inside the rectangular box 402 since they are bound. Also, a child indicator having a “+” sign inside it 412 appears on a center of right vertical line of a rectangular box standing for F 402, which specifies that FType has child elements, but they are folded.

FIG. 4B shows the next schema diagram displayed at the graphical view 206 when the user clicks on the child indicator 412 of element F 402 in FIG. 4A. In FIG. 4B, the sign inside the child indicator 414 of FType 402 has changed from “+” into “−”, and FType is connected to all four child elements 404, 406, 408, 410 with separate horizontal arrows respectively. In the conventional schema diagram of the figure, two child elements D 404 and E 406 inherited from datatype BType are surrounded with a dashed box 416, thus the user can visually differentiate them with child elements G 408 and H 410 locally declared in FType. Over the dashed box 416, there is datatype name BType 418. This is a supertype of FType. If the user wants to navigate to the supertype, the user can select BType from the list view 204 of FIG. 2.

FIG. 4C shows the next schema diagram displayed at the graphical view 206 when the user selects BType from the list view 204 of FIG. 2. In the figure, a child indicator having a “+” sign inside it 426 appears on a center of right vertical line of a rectangular box standing for BType 420, which specifies that BType has child elements, but they are folded.

FIG. 4D shows the next schema diagram displayed at the graphical view 206 when the user clicks on the child indicator 426 in FIG. 4C. In FIG. 4D, the sign inside the child indicator 428 of BType 420 has changed from “+” into “−”, and BType is connected to its child elements D 422 and E 424 with separate horizontal arrows respectively.

In the schema diagrams of conventional schema browsers in FIGS. 4A, 4B, 4C and 4D, the inheritance relationship between two datatypes are not graphically described when a datatype having its subtypes is being navigated. So, users are not able to navigate to the subtypes from the given datatype. That is, downward navigation might not be possible. For example, users might not be able to navigate to FType or IType that are the subtypes of BType, when staying at BType in FIG. 4D. In the meanwhile, when a datatype having supertypes is being navigated, the inheritance relationship is implicitly described by surrounding all inherited child elements of the datatype with a dashed box. Above the dashed box, there is a supertype name. Using the supertype name, users can navigate to the supertype from the given datatype. That is, upward navigation might be possible. For example, users can navigate to BType that is the supertype of FType, when staying at FType in FIG. 4B. However, the two composition/aggregation hierarchies rooted at FType and BType cannot co-exist in the graphical view 206 of FIG. 2 though the upward navigation from FType to BType might be possible. That is, one of schema diagrams FIG. 4B or 4D can be displayed at the graphical view. This will be inconvenient for users who want to view the two structures at the same time. Note that, if BType has its own supertype and a user has navigated from FType, BType and the supertype of BType in sequence, it might be very hard for the user to return to FType again.

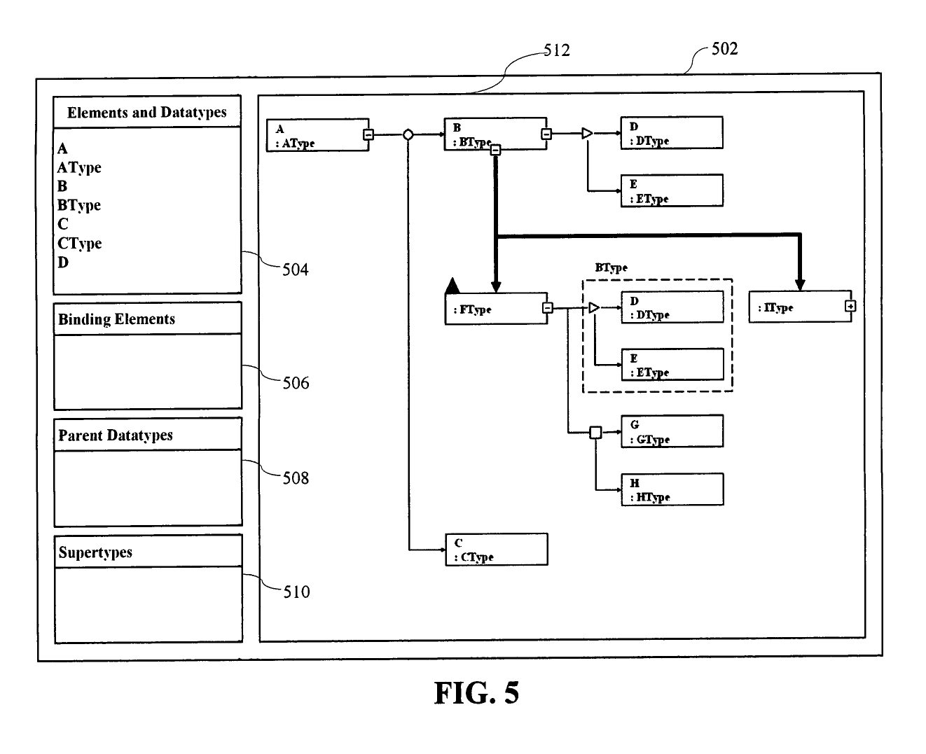

FIG. 5 illustrates an exemplary GUI screen of a graphical schema browser, according to an embodiment of the techniques disclosed herein. The GUI screen 502 comprises five major parts:

a list view of schema components 504,

a list view of binding elements 506,

a list view of parent datatypes 508,

a list view of supertypes 510, and

a graphical view of schema diagram 512.

At first glance, the browser parts 504 and 512 of the GUI in FIG. 5 may seem to be similar to the parts 204 and 206 of the previously-described conventional GUI in FIG. 2. That is, the list view of schema components 504 also provides a list of all datatypes and elements defined in an XML Schema document, and the graphical view of schema diagram 512 also provides a composition/aggregation hierarchy rooted at a component when a user selects the schema component in the list view 504. However, there are significant differences between the two GUIs. First, the list view of schema components 504 provides a list of “all” datatypes and elements defined in an XML Schema document including global and local elements, and complex and simple datatypes. Second, the graphical view of schema diagram 512 provides not only a composition/aggregation hierarchy but also an inheritance hierarchy. The schema diagram provided by 512 is the diagram described in FIG. 1.

The exemplary GUI screen in FIG. 5 allows users to easily navigate through datatypes and elements backward along a composition/aggregation hierarchy. In XML Schema, a datatype can be associated with several elements. In order to navigate backward from a datatype, a binding element of the datatype has to be selected among feasible binding elements of the datatype. Similarly, an element can be contained in several datatypes. That is, an element can have several parent datatypes. In order to navigate backward from an element, a parent datatype of the element has to be selected among feasible parent datatypes of the element. The lists 506 and 508 are devised to meet these purposes. The list view of binding elements 506 provides a list of feasible binding elements of a datatype if they exist. The list view of parent datatypes 508 provides a list of feasible parent datatypes of an element if they exist. By clicking on a list item of the lists 506 and 508 respectively, users can select one of the binding elements of a given datatype and then one of the parent datatypes of the selected binding element, or select one of the parent datatype of a given element and then one of the binding elements of the selected parent datatype.

Similarly, the exemplary GUI screen in FIG. 5 allows users to easily navigate through datatypes upward along an inheritance hierarchy. In XML Schema, a datatype can have multiple supertypes when the datatype is defined as a union or list of multiple datatypes. In order to navigate upward from a datatype, a supertype of the datatype has to be selected among feasible supertypes of the datatype. The list 510 is devised to meet the purpose. The list view of supertypes 510 provides a list of feasible supertypes of a datatype if they exist. By clicking on a list item of the list 510, users can select one of the supertypes of a given datatype to navigate.

The five parts incorporated in the exemplary GUI screen illustrated in FIG. 5 are tightly inter-related and synchronized in terms of event handling when being displayed. Together, they offer an integrated framework for graphically navigating forward, backward, upward and downward from a given datatype or element. Each of the five views (504, 506, 508, 510, 512) is encapsulated into its own GUI object through which requests are received from a user and the responses to the requests are returned to the user. To support an integrated framework for browsing an XML Schema document, the five views are designed to exchange close interactions with one another so that the effects of handling requests made via one particular view are reflected not only on the request-originating view, but are dynamically updated on the other views.

For example, suppose that a schema diagram of an XML Schema document is displayed at the graphical view 512. If a user selects an element by clicking on the rectangular box standing for the element at the graphical view 512, the element now becomes a “current element” and the box is highlighted with a shaded color inside the box or bold line along the box's perimeter. Then, the selected element is highlighted at the list view of schema components 504, and all feasible parent datatypes of the element are displayed at the list view of parent datatypes 508. Also, if the user selects a datatype at the list view of parent datatypes 508, the selected datatype becomes a new “current datatype” and the rectangular box standing for the datatype is highlighted at the graphical view 512. Then, the selected datatype is highlighted at the list view of schema components 504, all feasible binding elements of the datatype are displayed at the list view of binding elements 506, all feasible supertypes of the datatype is displayed at the list view of supertypes 510. (The elements D and E occur twice in FIG. 5 because elements D and E of FType are inherited from BType.)

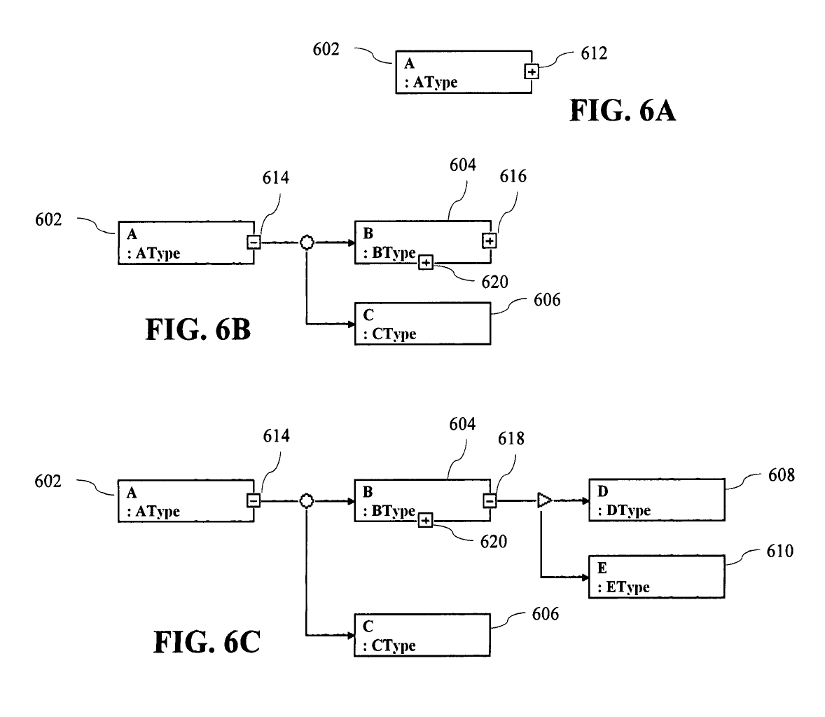

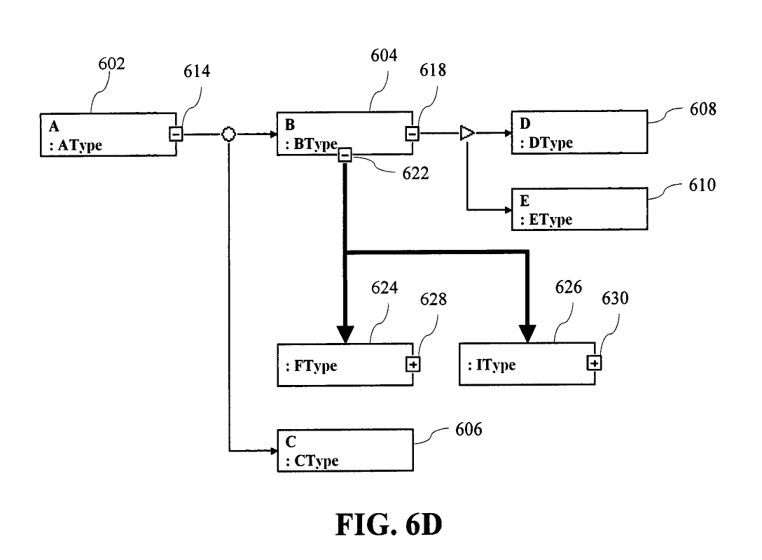

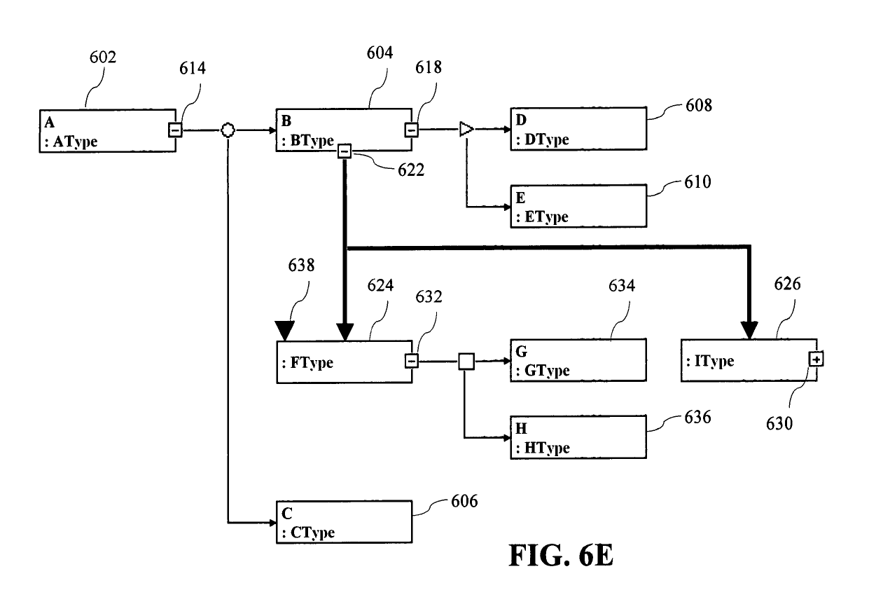

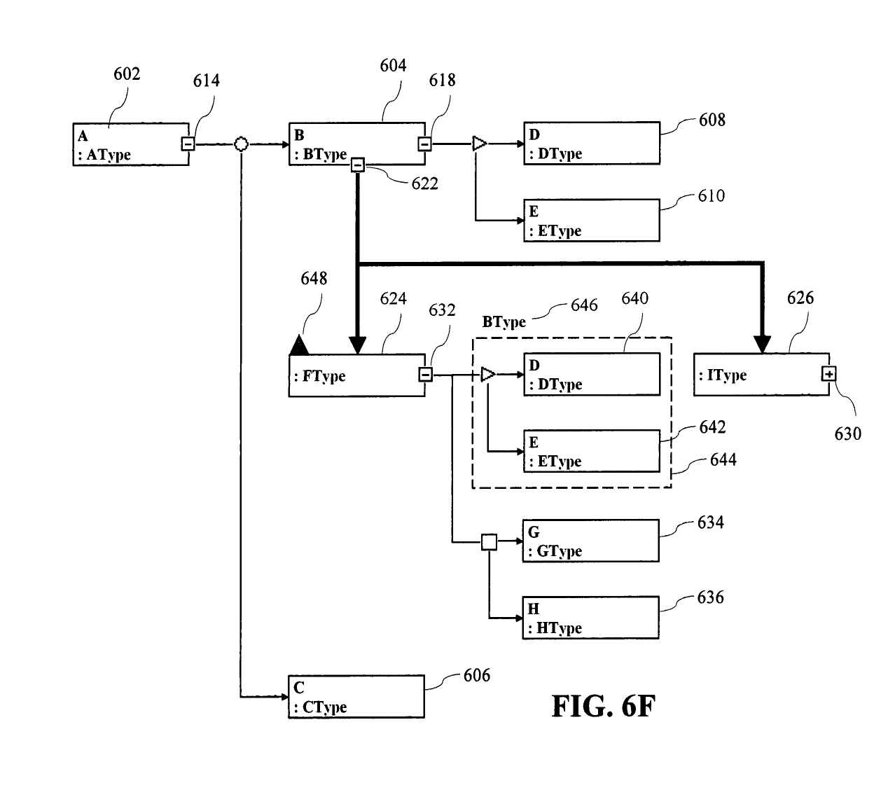

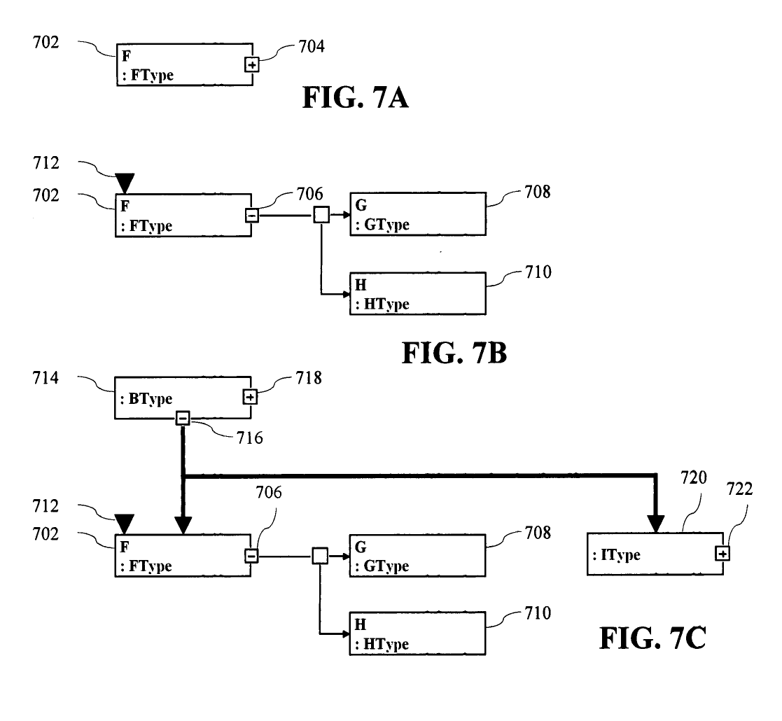

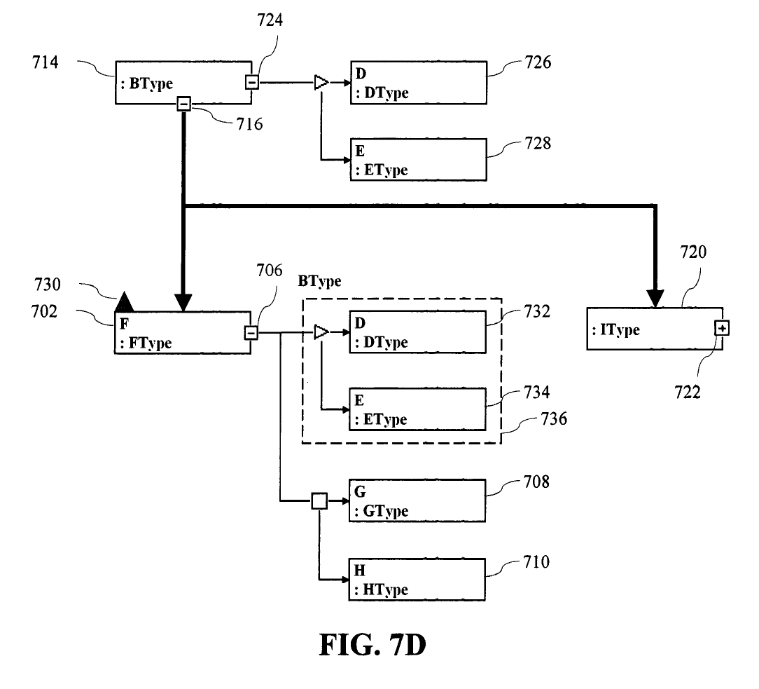

FIGS. 6A, 6B, 6C, 6D, 6E, 6F and 7, further describe the graphical backward, upward and downward navigation capabilities of the GUI screen of FIG. 5. FIGS. 6A, 6B, 6C, 6D, 6E, 6F illustrate six consecutive exemplary schema diagrams that are displayed in sequence at the graphical view of schema diagram 512 of the exemplary GUI screen 502 in FIG. 5, when navigating forward and downward from element A in Table 1, according to an embodiment of the techniques described herein. These figures illustrate the graphical forward and downward navigation capabilities of the the techniques described herein.

FIG. 6A shows an exemplary schema diagram displayed at the graphical view 512 when a user selects element A from the list view 504 in FIG. 5. In the figure, element A and datatype AType are inside the rectangular box 602 since they are bound. Also, the child indicator having a “+” sign inside it 612 appears on a center of right vertical line of the box standing for datatype AType. This figure is the same as FIG. 3A.

FIGS. 6B, 6C, 6D, 6E and 6F are schema diagrams which would be displayed at the graphical view 512 that conventional graphical schema browsers do not provide, but which a conventional graphical schema browser could provide by incorporating the techniques disclosed herein.

FIGS. 6B and 6C show the next two schema diagrams displayed at the graphical view 512 when the user clicks on the child indicators 612 and 616 of AType and BType in FIGS. 6A and 6B in succession. These figures are almost the same as FIGS. 2B and 2C except that the existence of the small square having a “+” sign inside 620 it appears on a center of bottom horizontal line of a box representing BType 604. The “+” sign is a “subtype indicator” that always appears on a center of bottom horizontal line of a box representing a datatype when the datatype has subtypes. The subtype indicator having a “+” sign inside it specifies that a datatype having the indicator has its subtypes, but they are folded. Similarly, the subtype indicator having a “−” sign inside it specifies that a datatype having the indicator has its subtypes, and they are unfolded. The subtype indicator also acts as a toggle switch. That is, the subtypes of a datatype can be folded and unfolded by clicking on the subtype indicator of the datatype. With the disclosed technique, the user can navigate to the subtypes of BType 604 just by the visual hint on the existence of the subtype indicator 620 of BType 604.

FIG. 6D shows the next schema diagram displayed at the graphical view 512 when the user clicks on the subtype indicator 620 of BType 604 in FIG. 6C. In FIG. 6D, the sign inside the subtype indicator 622 of BType 604 has changed from “+” into “−”, and the subtypes FType 624 and IType 626 of BType 604 are unfolded by connecting base datatype BType 604 to FType 624 and IType 626 with two bold vertical arrows, respectively. With the disclosed technique, by just simple glancing at the box standing for BType 604 and around it, the user now can have a clear view on its child elements or datatypes DType 608 and EType 610 and also its subtypes FType 624 and IType 626.

With the disclosed technique, when the child elements of a subtype are unfolded by clicking on a child indicator of the subtype, they can be graphically represented either in one of two modes: “inherited” and “un-inherited” modes. In the inherited mode of a subtype, all child elements that are not only locally declared in the subtype but also inherited from its supertypes are unfolded. But, in the un-inherited mode of a subtype, only child elements that are locally declared in the subtype are unfolded. The two modes are graphically represented with an “inheritance mode indicator”.

FIG. 6E shows the next schema diagram displayed at the graphical view 512 which will appear when the user clicks on the child indicator 628 of subtype FType 624 in FIG. 6D. In FIG. 6E, the sign inside the child indicator 632 of FType 624 has changed from “+” into “−”, and the child elements G 634 and H 636 of FType 624 are unfolded by connecting FType to G and H with two horizontal arrows, respectively. Above the box representing FType 624, there is a small inverted triangle 634. The inverted triangle symbol is an “inheritance mode indicator” that appears above a subtype when the child elements of the subtype are unfolded by clicking on a child indicator of the subtype. A subtype with an inheritance mode indicator having an inverted triangle specifies that the child elements of the subtype are graphically represented in the un-inherited mode. Similarly, a subtype with an inheritance mode indicator having a regular (not inverted) triangle specifies that the child elements of the subtype are graphically represented in the inherited mode. The inheritance mode indicator also acts as a toggle switch. That is, the inheritance mode of a subtype is switched between the inherited and un-inherited modes by clicking on the inheritance mode indicator of the datatype. In FIG. 6E, subtype FType 624 of datatype BType 604 has the inheritance mode indicator having an inverse triangle 638. Thus, only the child elements G 634 and H 636 that are locally declared in FType 624 are unfolded.

FIG. 6F shows the next schema diagram displayed at the graphical view 512 which will appear on the screen when the user clicks on the inheritance mode indicator 638 of FType 624 in FIG. 6E. In FIG. 6F, the inheritance mode indicator 648 of subtype FType 624 has changed from an inverted triangle into a regular triangle. Also, all child elements of FType 624 that are not only locally declared in the subtype such as elements G 634 and H 636 but also inherited from its supertypes such as elements D 640 and E 642 are unfolded. In FIG. 6F, the inherited elements D 640 and E 642 are surrounded by a dashed box 644 above which its supertype name BType 646 appears.

FIGS. 7A, 7B, 7C, 7D illustrate four consecutive exemplary schema diagrams that would be displayed, in sequence, in the graphical view of schema diagram 512 of the exemplary GUI screen 502 in FIG. 5, when navigating upward from a particular element having a supertype, for example, element F in Table 1. These figures illustrate an example of the graphical upward navigation capability of the techniques of the present disclosure.

FIG. 7A shows an exemplary schema diagram which would be displayed at the graphical view 512 when a user selects element F whose datatype is FType from the list view 504 in FIG. 5. In the figure, element F and datatype FType are inside the rectangular box 702 since they are bound. Also, the child indicator having a “+” sign inside it 704 appears on a center of right vertical line of the box standing for datatype FType.

FIGS. 7B, 7C and 7D are schema diagrams that conventional graphical schema browsers do not provide, but which a conventional graphical schema browser could provide by incorporating the techniques disclosed herein.

FIG. 7B shows the next schema diagram which would be displayed at the graphical view 512 when the user clicks on the child indicator 704 of FType 702 in FIG. 7A. Because FType has a supertype, an inheritance mode indicator having an inverted triangle 712 appears above the box representing FType 702 when child elements G 708 and H 710 of FType 702 are unfolded. When the user is looking at appearance of the inheritance mode indicator 712 when unfolding the child elements, the user can recognize that FType 702 has supertypes. Furthermore, the supertype of FType, BType, would be displayed in the list view of supertypes 510 of the exemplary GUI screen 502 in FIG. 5 since the FType is the current datatype. Thus, the user could also easily recognize the existence of supertype BType just by glancing at the list view 510. The user can then decide to navigate upward to the supertype by clicking on the list item BType (not shown) which would be displayed in the list view 510.

FIG. 7C shows the next schema diagram which would be displayed at the graphical view 512 when the user clicks on the list item BType which would be displayed in the list view of supertypes 510 in FIG. 5. In FIG. 7C, the box standing for supertype BType 714 is connected to the box standing for datatype FType 702 with a bold vertical arrow, and a subtype indicator having a “−” sign inside it 716 is on BType 714. The rectangular box 714 is also connected to the box standing for datatype IType 720 with a bold vertical arrow since IType is another subtype of BType. On the BType 714 and IType 720, there are also another kind of indicators, that is, two child indicators having a “+” sign inside them 718 and 722 specifying that the datatype has child elements, but they are folded.

FIG. 7D shows the next schema diagram which would be displayed at the graphical view 512 when the user clicks on the child indicator having a “+” sign inside it 718 of BType 714 and the inheritance mode indicator having an inverted triangle 712 of FType 702 in FIG. 7C. In FIG. 7D, the user can clearly know the schema structure of FType including all child elements D 732, E 734, G 708, H 710 and supertype BType 714. If FType would has its own subtypes, another subtype indicator could appear on a center of bottom line of the box standing for FType 702. Thus, the subtypes of FType might also be unfolded by clicking on the subtype indicator of FType.

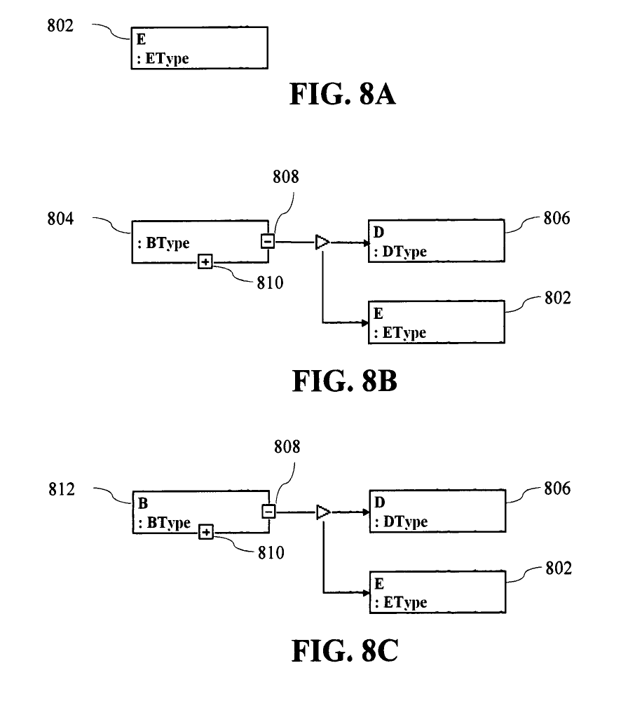

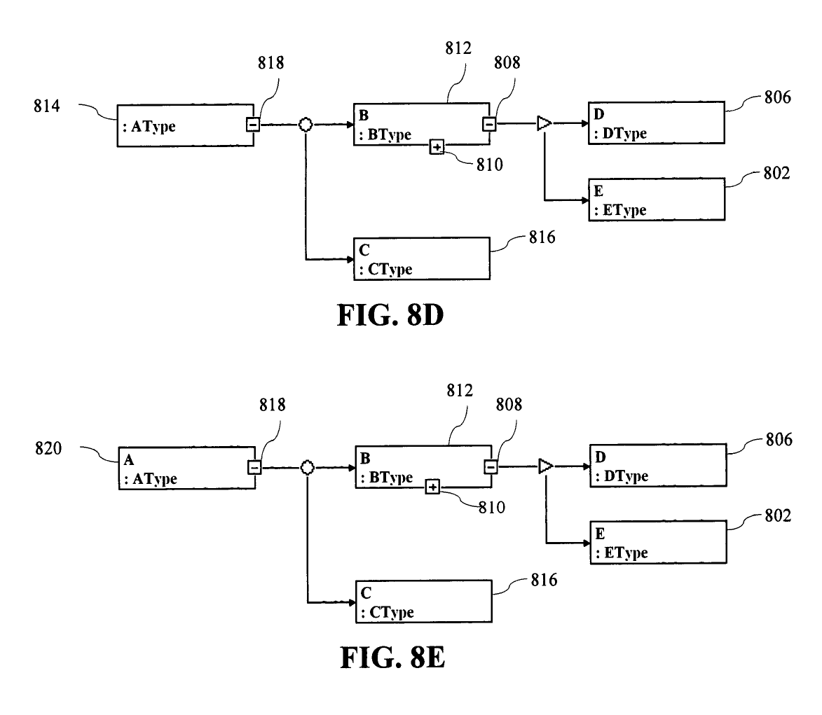

FIGS. 8A, 8B, 8C, 8D and 8E illustrate five consecutive exemplary schema diagrams which would be displayed in sequence at the graphical view of schema diagram 512 of the exemplary GUI screen 502 in FIG. 5, when navigating backward from a particular element having parent datatypes, for example, element E in Table 1, according to an example of the techniques of the present disclosure. These figures are for showing the graphical backward navigation capability of the techniques of the present disclosure.

FIG. 8A shows an exemplary schema diagram which would be displayed at the graphical view 512 when a user selects element E whose datatype is EType from the list view of schema components 504 in FIG. 5. In the figure, element E and datatype EType are inside the rectangular box 802 since they are bound. Since E is the current element, the parent datatype of E (BType) would be displayed at the list view of parent datatypes 508 of the exemplary GUI screen 502 in FIG. 5. Thus, the user could easily recognize the existence of the parent datatype simply by glancing at the list view 508. The user could then decide to navigate backward to the parent datatype by clicking on the list item BType which would be displayed in the list view 508.

FIG. 8B shows the next schema diagram which would be displayed at the graphical view 512 when the user clicks on the list item BType in the list view of parent datatypes 508 in FIG. 5. In FIG. 8B, the rectangular box standing for parent datatype BType 804 is connected to the box standing for element E 802 with a horizontal arrow. The box 804 is also connected to the box standing for element D 806 since element D is another child of BType. A child indicator having a “−” sign inside it 808 is on the right side of the box BType 804, which specifies that the datatype has child elements, and they are unfolded. A subtype indicator having a “+” sign inside it 810 is on the bottom side of the box BType 804, which also specifies that the datatype has subtypes but they are folded. Since BType is the current datatype, the binding element of BType (B) is displayed at the list view of binding elements 506 of the exemplary GUI screen 502 in FIG. 5. Thus, the user could easily recognize the existence of the binding element just by glancing at the list view 506. The user could then decide to associate element B with datatype BType by clicking on the list item B which would be displayed in the list view 506.

FIG. 8C shows the next schema diagram which would be displayed at the graphical view 512 when the user clicks on the list item B in the list view of binding elements 506 in FIG. 5. In FIG. 8C, the rectangular box 812 has not only BType but also B, which tells that element B is now associated with datatype BType. Since element B becomes the new current element, the parent datatype of B (AType) would be displayed at the list view of parent datatypes 508 of the exemplary GUI screen 502 in FIG. 5. Thus, the user could easily recognize the existence of the parent datatype just by glancing at the list view 508. The user could then decide to navigate backward to the parent datatype by clicking on the list item AType which would be displayed in the list view 508.

FIG. 8D shows the next schema diagram which would be displayed at the graphical view 512 when the user clicks on the list item AType in the list view of parent datatypes 508 in FIG. 5. In FIG SD, the rectangular box standing for parent datatype AType 814 is connected to the box standing for element B 812 with a horizontal arrow. The box 814 is also connected to the box standing for element C 816 since element C is another child of AType. A child indicator having a “−” sign inside it 818 is on the right side of the box AType 814, which specifies that the datatype has child elements, and they are unfolded. Since AType becomes the new current datatype, the binding element of AType (A) is displayed at the list view of binding elements 506 of the exemplary GUI screen 502 in FIG. 5. Thus, the user could easily recognize the existence of the binding element just by glancing at the list view 506. The user could also decide to associate element A with datatype AType by clicking on the list item B which would be displayed in the list view 506.

FIG. 8E shows the next schema diagram displayed which would be displayed at the graphical view 512 when the user clicks on the list item A in the list view of binding elements 506 in FIG. 5. In FIG. 8E, the rectangular box 820 has not only AType but also A, which tells that element A is now associated with datatype AType. Since element A would become the new current element but does not have any parent datatype, there would be nothing to be displayed at the list view of parent datatypes 508 of the exemplary GUI screen 502 in FIG. 5. Thus, the user can not navigate backward any more.

Generally speaking, an element X associated with a binding datatype XType can have child elements, parent datatypes, supertypes and subtypes along all feasible directions of navigations. According to the techniques disclosed herein, the existence of child elements and subtypes are visually specified at the graphical view of schema diagram 512 in FIG. 5 with the child indicator and subtype indicator respectively. Also, another existence of parent datatypes is not directly specified at the graphical view 512. Rather, it is indirectly specified by displaying all feasible binding elements at the list view of binding elements 506 and displaying all feasible parent datatypes of a selected binding element in the list view of parent elements 508 in FIG. 5. Furthermore, the other existence of supertypes is not directly specified at the graphical view 512, but rather is indirectly specified by displaying all feasible supertypes at the list view of supertypes 510 in FIG. 5. The existence of the parent datatypes and supertypes can be visually specified at the graphical view of schema diagram 512 in FIG. 5 with two new indicators: parent indicator and supertype indicator.

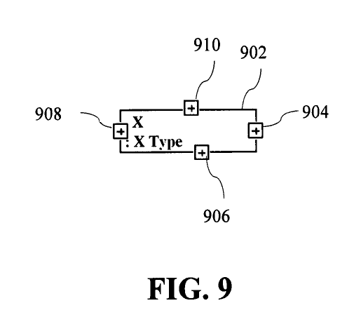

FIG. 9 illustrates an exemplary schema component 902 standing for an element, a datatype or an element associated with a datatype, shown at the graphical view of schema diagram 512 of the exemplary GUI screen 502 in FIG. 5, according to an embodiment of the techniques of the present disclosure. In the figure, a schema component can have not only a child indicator 904 and a subtype indicator 906, but can also have a parent indicator 908 and a supertype indicator 910 if the schema component 902 has at least one child element, subtype, parent datatype and supertype, respectively. The visual actions of the new parent indicator 908 and a supertype indicator 910 are similar to those of the child indicator 904 and the subtype indicator 906. That is, the parent indicator 908 having a “+” sign inside it specifies that an element having the indicator has its parent datatypes, but they are folded. Similarly, the element indicator 908 having a “−” sign inside it indicates that the element having the indicator has parent datatypes, and they are unfolded. The parent indicator 908 also acts as a toggle switch. That is, the parent datatypes of an element are folded and unfolded by clicking on the parent indicator of the element. Also, the supertype indicator 910 having a “+” sign inside it indicates that a datatype having the indicator has its supertypes, but they are folded. Similarly, the supertype indicator 910 having a “−” sign inside it indicates that the datatype having the indicator has supertypes, and they are unfolded. The supertype indicator 910 also acts as a toggle switch. That is, the supertypes of a datatype are folded and unfolded by clicking on the supertype indicator of the datatype.

A benefit of the techniques of the present disclosure is that the user can easily know the existence of child elements, parent datatypes, subtypes and supertypes of a schema component 902 simply by glancing at the component, and then navigate forward, backward, downward, and upward from the schema component 902 by clicking on the indicators. Furthermore, by a user's request such as clicking on each indicator, a corresponding pop-up menu can be provided to the user. In the pop-up menu, a list of feasible child elements, subtypes, parent datatypes or supertypes of a schema component is displayed. If the user selects one list item in the list, partial schema diagram related to the selected item will be unfolded at the graphical view 512 in FIG. 5.

Based on the teachings set forth herein, the exemplary schema diagram in FIG. 1 and the exemplary GUI screen of a graphical schema browser in FIG. 5 can readily be applied to current graphical schema editors by slight modification and addition to the diagram and GUI screen. Currently, most users of XML Schema are making their own XML Schema documents with textual editors. If they were to have a graphical schema editor, such as is disclosed herein, they could edit the documents faster and more easily.

The exemplary schema diagram in FIG. 1 and the exemplary GUI screen of a graphical schema browser in FIG. 5 could be useful for browsing the international standard XML schema documents specified in MPEG-7 and TV-Anytime. Also, they are useful for browsing the XML Schema document for multimedia bookmark that is utilized by U.S. patent application Ser. No. 09/911,293 filed Jul. 23, 2001 (Publication No. 2002/0069218). Furthermore, they are useful for browsing the XML schema documents that are utilized by the real-time indexer of U.S. patent application Ser. No. 10/369,333 filed Feb. 19, 2003 (Publication No. 2003/0177503) and by the system of U.S. patent application Ser. No. 10/368,304 filed Feb. 18, 2003 (Publication No. 2004/0125124).

It will be apparent to those skilled in the art that various modifications and variations can be made to the techniques described in the present disclosure. Thus, it is intended that the present disclosure covers the modifications and variations of the techniques, provided that they come within the scope of the appended claims and their equivalents.

1. A Graphical User Interface (GUI) representing composition/aggregation relationships in an XML Schema document comprising:
means for providing tree views that represent a composition/aggregation hierarchy between related datatypes and elements;
means for graphically representing inheritance relationships indirectly through the composition/aggregation hierarchy; and
means for graphically representing an inheritance hierarchy while displaying the composition/aggregation hierarchy.

2. The GUI of claim 1, further comprising:
for a given datatype in the composition/aggregation hierarchy of the XML Schema document, means for providing “backward” navigation from an element or a datatype to its parent datatype.

3. The GUI of claim 1, wherein:
the GUI graphically supports not only forward but also backward navigation capabilities.

4. The GUI of claim 3, further comprising:
means for providing a graphical indication for existence of binding elements of a given datatype and another graphical indication for existence of parent datatypes of a given element; and
means for providing graphical tools with which users can choose one of the binding elements of a given datatype and one of the parent datatypes of a given element.

5. The GUI of claim 1, further comprising:
means for providing a graphical indication for existence of subtypes and links to them; and
means for providing graphical tools with which users can navigation downward from a datatype to one of its subtypes.

6. The GUI of claim 1, further comprising:
means for providing a graphical indication for existence of supertypes and links to them; and
means for providing graphical tools with which users can navigation upward from a datatype to one of its supertypes.

7. A method of providing a graphical representation of a semantic structure of an XML Schema document, comprising:
explicitly representing composition/aggregation relationships between related datatypes and their child elements and inheritance relationships between supertypes and subtypes in a single GUI screen of a graphical schema browser; and
generating a compact graphical schema diagram for representing complex relationships between datatypes and elements inherent the XML schema document by providing means for easily and quickly browsing the graphical schema diagram.

8. The method of claim 7, further comprising:
providing a schema diagram representing composition/aggregation relationships between datatypes and elements and inheritance relationships between datatypes;
in the schema diagram, representing each schema component including an element, a datatype, or an element associated with a datatype with a rectangular box;
in the schema diagram, providing an element name, a datatype name or element name and datatype name inside the rectangular box;
in the schema diagram, providing horizontal arrows that represent composition/aggregation relationships between datatypes and elements;
in the schema diagram, providing vertical arrows that represent inheritance relationships between datatypes;
in the schema diagram, representing each compositor with a graphical symbol located on the horizontal arrow standing for a composition/aggregation relationship.

9. The method of claim 8, further comprising:
utilizing the schema diagram for any graphical diagram representing composition/aggregation relationships and inheritance relationships between objects or datatypes concurrently in a single diagram.

10. The method of claim 8, further comprising:
utilizing the schema diagram for any graphical XML Schema editor that can edit XML Schema document with the graphical means of the schema diagram.

11. A method of browsing a schema diagram of related XML Schema documents with a graphical schema browser that can control the navigations through the schema diagram, comprising:
providing a GUI screen for the browser, the GUI screen comprising:
a list view of schema components,
a list view of binding elements,
a list view of parent datatypes,
a list view of supertypes, and
a graphical view of schema diagram;
wherein the list view of schema components provides a list of all datatypes and elements defined in related XML Schema documents including global and local elements, and complex and simple datatypes, and by selecting a datatype or element from the list, the rectangular box standing for the selected datatype or element appears at the graphical view of schema diagram, and users can start to navigate from the selected one;
wherein the list view of binding elements provides a list of feasible binding elements of a datatype if they exist, and by selecting an element from the list, the datatype is associated with the element;
wherein the list view of parent datatypes provides a list of feasible parent datatypes of an element if they exist, and by selecting a parent datatype from the list, the rectangular box standing for the selected parent datatype appears at the graphical view of schema diagram, and users can navigate backward from the element to the selected parent datatype;
wherein the list view of supertypes provides a list of feasible supertypes of a datatype if they exist, and by selecting a supertype from the list, the rectangular box standing for the selected supertype appears at the graphical view of schema diagram, and users can navigate upward from the datatype to the selected supertype.

12. The method of claim 11, wherein:
the graphical view of schema diagram comprises a graphical element standing for a datatype, and the graphical element can have a subtype indicator for indicating when subtypes of the datatype exist, and by clicking on the subtype indicator, the subtypes become unfolded and users can navigate downward through the unfolded subtypes, and by clicking on the indicator again, the subtypes become folded.

13. The method of claim 11, wherein:
the graphical view of schema diagram comprises a graphical element standing for a datatype, and the graphical element can have a supertype indicator for indicating when supertypes of the datatype exist, and by clicking on the supertype indicator, the supertype becomes unfolded and users can navigate upward through the unfolded supertypes, and by clicking on the indicator again, the subtypes become folded.

14. The method of claim 11, wherein:
the graphical view of schema diagram comprises a graphical element standing for an element, and the graphical element can have a parent indicator when the parent datatypes of the element exist, and by clicking on the parent indicator, the parent datatype becomes unfolded and users can navigate backward through the unfolded parent datatypes, and by clicking on the indicator again, the parent datatype becomes folded.

15. The method of claim 11, wherein:
in the graphical view of schema diagram at the GUI screen of the graphical schema browser, child elements of a subtype are graphically represented either in one of inherited or un-inherited mode, when they are unfolded, wherein:
in the inherited mode of a subtype, all child elements that are not only locally declared in the subtype but also inherited from its supertypes are unfolded, and
in the un-inherited mode of a subtype, only child elements that are locally declared in the subtype are unfolded: and
the two modes can be switched each other using an inheritance indicator appearing around the subtype when the child elements of the subtype are unfolded.

16. The method of claim 11, further comprising:
utilizing the method of browsing a schema diagram for any graphical XML Schema editor that can edit XML Schema document with the GUI screen views.
